(19) United States
(12) Patent Application Publication
(10) Pub. No.: US 2017/0057491 A1
(43) Pub. Date: Mar. 2, 2017

(54) HYBRID VEHICLE

(71) Applicant: TOYOTA JIDOSHA KABUSHIKI KAISHA, Toyota-shi (JP)

(72) Inventor: Masashi YOSHIMI, Toyota-shi (JP)

(73) Assignee: TOYOTA JIDOSHA KABUSHIKI KAISHA, Toyota-shi (JP)

(21) Appl. No.: 15/242,982

(22) Filed: Aug. 22, 2016

(30) Foreign Application Priority Data
Aug. 28, 2015 (JP) 2015-169210

(51) Int. Cl. B60W 20/50; B60K 6/26; B60W 10/08; B60W 20/40; B60W 10/06; B60K 6/44; B60K 6/365

(52) U.S. Cl. CPC B60W 20/50; B60K 6/44; B60K 6/26; B60K 6/365; B60W 20/40; B60W 10/06; B60W 10/08; B60K 2006/268; B60W 2530/00; B60Y 2200/92; B60Y 2306/13; Y10S 903/906; Y10S 903/93

(57) ABSTRACT

A planetary gear mechanism mechanically couples an engine, a first motor generator and a drive shaft. A second inverter is configured to control power supply to the second motor generator coupled to the drive shaft, the second inverter being a multi-phase and full-bridge type inverter having an upper arm and a lower arm in each phase. The controller executes specific control for starting the engine when the hybrid vehicle is in a stopped state and an abnormality occurs in the second motor generator. The specific control includes: (i) first control for controlling the engine to be cranked with the first motor generator; and (ii) second control for controlling the upper arm of each phase or the lower arm of each phase of the second inverter to be turned into an ON state.

This nonprovisional application is based on Japanese Patent Application 2015-169210 filed on Aug. 28, 2015, with the Japan Patent Office, the entire contents of which are hereby incorporated by reference.

### BACKGROUND OF THE INVENTION

Field of the Invention

The present invention relates to a hybrid vehicle.

Description of the Background Art

In conventional hybrid vehicles, in order to absorb fluctuations in cranking torque transmitted to the side of driving wheels during cranking of an engine, specific control is executed to cancel the fluctuation torque by applying a torque in the direction opposite to the fluctuation torque transmitted by a motor (for example, see PCT International Publication No. WO02/04806).

### SUMMARY OF THE INVENTION

However, in the case where there is an abnormality by which cancellation of the fluctuation torque cannot be controlled by the motor (motor generator), and particularly in the state where the vehicle is in a stopped state, the torque transmitted to the side of the driving wheels at the start of the engine cannot be cancelled, so that the drivability deteriorates.

The present invention has been made to solve the above-described problems. An object of the present invention is to provide a hybrid vehicle capable of cancelling a torque transmitted to the side of driving wheels at the start of an engine even in the case where an abnormality occurs in an electric motor.

The hybrid vehicle according to the present invention includes: an engine; a first motor generator; a drive shaft connected to driving wheels; a planetary gear mechanism mechanically coupling the engine, the first motor generator and the drive shaft; a second motor generator coupled to the drive shaft; a first inverter; a second inverter; and a controller. The first inverter is configured to control power supply to the first motor generator. The second inverter is configured to control power supply to the second motor generator, the second inverter being a multi-phase and full-bridge type inverter having an upper arm and a lower arm in each phase. The controller is configured to control outputs of the first motor generator, the second motor generator and the engine.

The controller is configured to execute specific control for starting the engine when the hybrid vehicle is in a stopped state and an abnormality occurs in the second motor generator. The specific control includes (i) first control for controlling the engine to be cranked with the first motor generator, and (ii) second control for controlling the upper arm of each phase or the lower arm of each phase of the second inverter to be turned into an ON state.

According to the present invention, even in the case where the hybrid vehicle is in a stopped state and an abnormality occurs in the second motor generator, when the first control is executed to transmit the start-up torque from the first motor generator to the engine, the torque transmitted from the first motor generator to the side of the driving wheels is cancelled by a drag torque generated from the second motor generator by executing the second control. Accordingly, it becomes possible to provide a hybrid vehicle capable of cancelling the torque transmitted to the side of the driving wheels at the start of the engine even in the case where an abnormality occurs in the motor generator.

Preferably, in a case where the engine is started when an abnormality occurs in the second motor generator and when a shift range is in a parking range, the controller is configured to stop the second inverter and start the engine using the first motor generator.

According to the present invention, in the case where the engine is started when the shift range is in a parking range, rotation of the second motor generator is mechanically locked. Accordingly, it is not necessary to cause the second motor generator to generate a torque for cancelling the torque transmitted to the side of the driving wheels. As a result, the engine can be started in the state where wasteful power consumption in the second inverter is eliminated.

Preferably, the planetary gear mechanism includes a sun gear coupled to an output shaft of the first motor generator, a ring gear coupled to an output shaft of the second motor generator, and a planetary carrier coupled to an output shaft of the engine. In a case where the engine is started when an abnormality occurs in the second motor generator, when a shift range is not in a parking range, when the vehicle speed is zero, and when driving force required by a user is zero, the controller is configured to mechanically lock the ring gear, and start the engine using the first motor generator.

According to the present invention, when the prescribed conditions are satisfied, the ring gear is locked and rotation of the second motor generator is mechanically locked. This eliminates the need to cause the second motor generator to generate a torque for cancelling the torque transmitted to the side of the driving wheels. Consequently, the engine can be started in the state where wasteful power consumption in the second inverter is eliminated.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration diagram of a hybrid vehicle according to an embodiment of the present invention.

FIG. 2 is a schematic diagram for illustrating details of a power train in the hybrid vehicle in FIG. 1.

FIG. 3 is a schematic block diagram showing the control configuration of motor generators MG1 and MG2.

FIG. 4 is a collinear diagram illustrating the relation between the rotation speed and the torque of each component in a power split device at the start of the engine in a normal case.

FIG. 5 is a diagram illustrating the relation between the torque and the rotation speed of motor generator MG2 during execution of three-phase ON control.

FIG. 6 is a collinear diagram illustrating the relation between the rotation speed and the torque of each component in the power split device at the start of the engine during execution of three-phase ON control for motor generator MG2.

FIG. 7 is a functional block diagram schematically showing the configuration for executing control for starting the engine at the time when an abnormality occurs in motor generator MG2 according to the present embodiment.

FIG. 8 is a flowchart illustrating the process flow of control for starting the engine at the time when an abnormality occurs in motor generator MG2.

FIG. 9 is a collinear diagram illustrating the relation between the rotation speed and the torque of each component in the power split device at the start of the engine in the case of a parking range.

FIG. 10 is a flowchart illustrating the process flow of a modification of control for starting the engine at the time when an abnormality occurs in motor generator MG2.

### DESCRIPTION OF THE PREFERRED EMBODIMENTS

The embodiments of the present invention will be hereinafter described in detail with reference to the accompanying drawings, in which the same or corresponding components are designated by the same reference characters, and description thereof will not be repeated.

[Configuration]

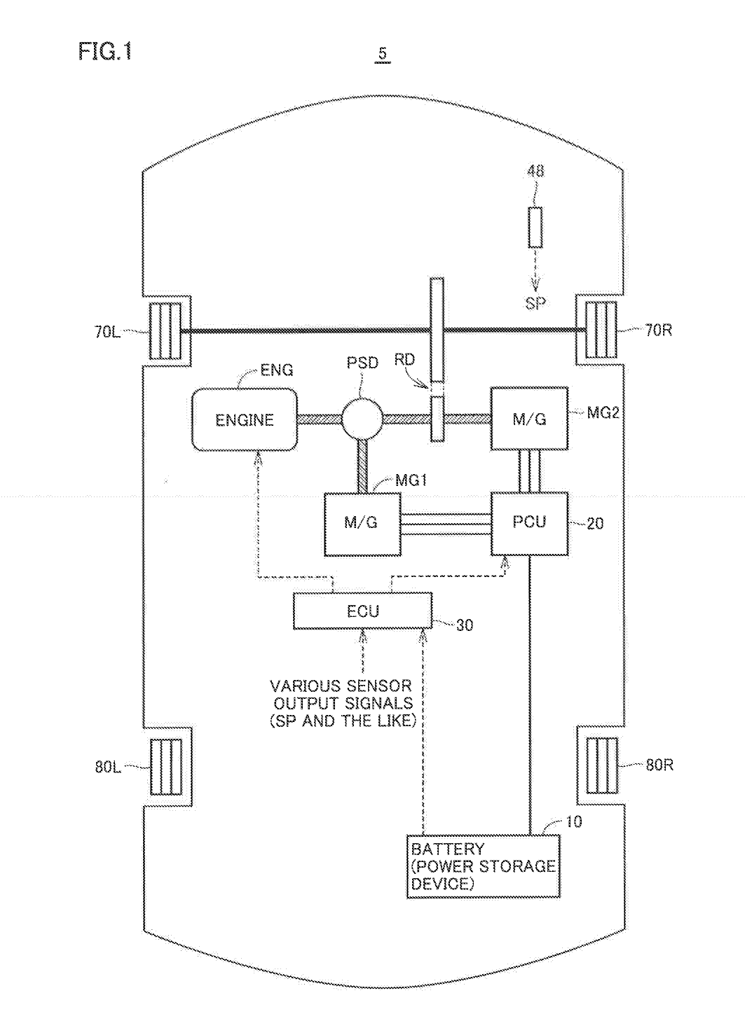

FIG. 1 is a schematic configuration diagram of a hybrid vehicle 5 according to an embodiment of the present invention. Referring to FIG. 1, hybrid vehicle 5 includes an engine ENG, motor generators MG1 and MG2; a battery 10, a power conversion unit (PCU) 20, a power split device PSD, a reduction gear RD, front wheels 70L and 70R, rear wheels 80L and 80R, and an electronic control unit (ECU) 30. The controller according to the present embodiment is implemented, for example, by a program executed by ECU 30. Although FIG. 1 shows hybrid vehicle 5 including front wheels 70L and 70R as driving wheels, rear wheels 80L and 80R may be used as driving wheels in place of front wheels 70L and 70R, or rear wheels 80L, and 80R may be used as driving wheels in place of front wheels 70L and 70R.

The driving force generated by engine ENG is divided by power split device PSD into two paths. One of the paths serves to drive front wheels 70L and 70R through reduction gear RD while the other of the paths serves to drive motor generator MG 1 to generate electric power.

Motor generator MG1 is representatively formed of a three-phase alternating-current (AC) synchronous motor generator. Motor generator MG1 serves as a power generator to generate electric power using driving force from engine ENG that is divided by power split device PSD. Furthermore, motor generator MG1 has not only a function as a power generator but also a function as an actuator for controlling the rotation speed of engine ENG.

The electric power generated by motor generator MG1 is used differently depending on the driving state of the vehicle, the SOC (State Of Charge) of battery 10, and the like. For example, during normal running or sudden acceleration of the vehicle, the electric power generated by motor generator MG1 turns into motive power for driving motor generator MG2 as a motor. On the other hand, when the SOC of battery 10 is lower than a predetermined value, the electric power generated by motor generator MG1 is converted by PCU 20 from AC power into direct-current (DC) power. Then, the converted DC power is stored in battery 10.

This motor generator MG1 is utilized also as a starter at the time when engine ENG is started. When engine ENG is started, motor generator MG1 receives electric power from battery 10 and performs a driving operation as an electric motor. Then, motor generator MG1 acts to crank engine ENG so as to be started.

Motor generator MG2 is representatively formed of a three-phase AC synchronous motor generator. In the case where motor generator MG2 is driven as an electric motor, this motor generator MG2 is driven by at least one of the electric power stored in battery 10 and the electric power generated by motor generator MG1. The driving force of motor generator MG2 is transmitted to front wheels 70L and 70R through reduction gear RD. Thereby, motor generator MG2 assists engine ENG to cause the vehicle to run, or uses only the driving force from motor generator MG2 to cause the vehicle to run.

During regenerative braking of the vehicle, motor generator MG2 is driven by front wheels 70L and 70R through reduction gear RD, so that this motor generator MG2 is operated as a power generator. Thereby, motor generator MG2 serves as a regenerative brake that converts braking energy into electrical energy. The electric power generated by motor generator MG2 is stored in battery 10 through PCU 20.

Battery 10 is a rechargeable electric power storage component, and configured to include, for example, a secondary battery such as a nickel-metal hydride battery or a lithium-ion battery. In the embodiment of the present invention, battery 10 is shown as a representative example of a “power storage device”. In other words, other power storage devices such as an electric double layer capacitor may also be used in place of battery 10. Battery 10 supplies a DC voltage to PCU 20 and is also charged by a DC voltage from PCU 20.

PCU 20 performs bidirectional power conversion between the DC power supplied by battery 10 and each of the AC power used for drive-controlling the motor and the AC power generated by the generator.

Hybrid vehicle 5 further includes a shill position sensor 48 that detects a shift position SP.

ECU 30 is electrically connected to engine ENG, PCU 20 and battery 10. Based on the detection signal from each of various sensors, ECU 30 controls the operation state of engine ENG, the driving states of motor generators MG1 and MG2, and the charged state of battery 10 in the integrated manner so as to bring hybrid vehicle 5 into a desired running state.

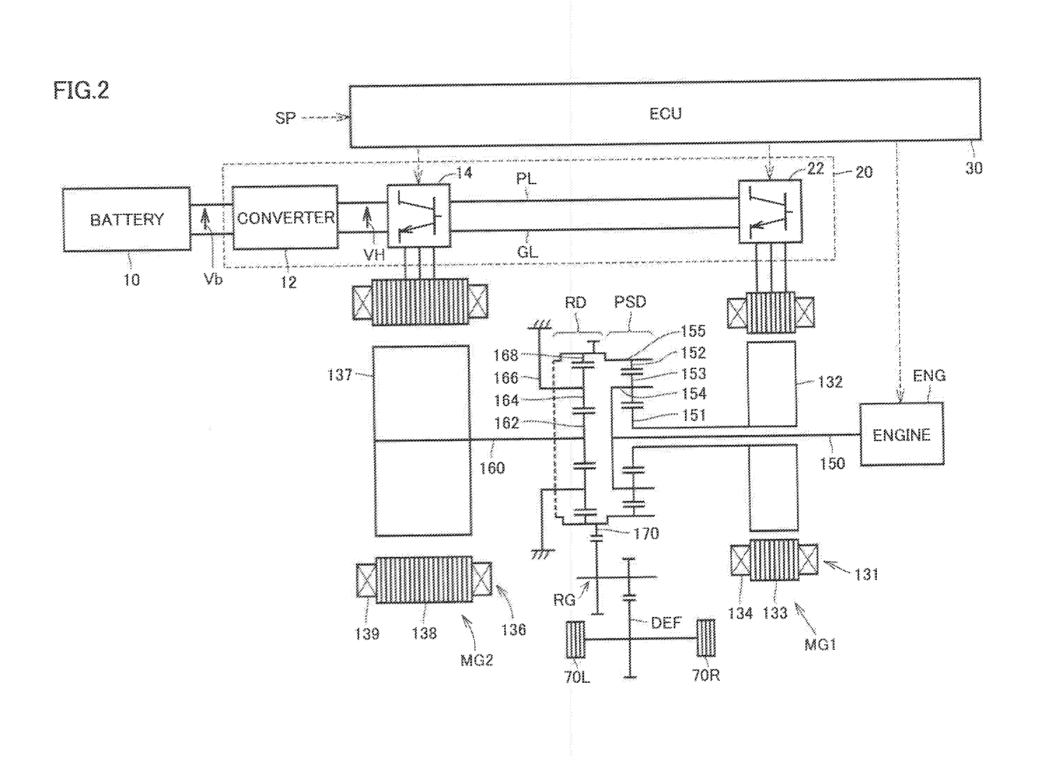

FIG. 2 is a schematic diagram for illustrating details of a power train in hybrid vehicle 5 in FIG. 1. Referring to FIG. 2, the power train (hybrid system) of hybrid vehicle 5 includes motor generator MG2, reduction gear RD connected to an output shaft 160 of motor generator MG2, engine ENG, motor generator MG1, and power split device PSD.

Power split device PSD is formed of a planetary gear mechanism in an example shown in FIG. 2. This power split device PSD includes: a sun gear 151 coupled to a hollow sun gear shaft having a shaft center through which crankshaft 150 passes; a ring gear 52 rotatably supported on the same axis as crankshaft 150; pinion gears 153 arranged between sun gear 151 and ring gear 152 and revolving around the outer circumference of sun gear 151 while rotating on their own axis; and a planetary carrier 154 coupled to an end portion of crankshaft 150 and supporting the rotation shaft of each pinion gear 153.

In power split device PSD, three shafts including a sun gear shaft coupled to sun gear 151, a ring gear case 155 coupled to ring gear 152, and a crank shaft 150 coupled to planetary carrier 154 serve as power input/output shafts. When each motive power input to/output from two shafts of these three shafts is determined, the motive power to be input to/output from the remaining one shaft is determined based on the motive power input to/output from the other two shafts.

A counter drive gear 170 for deriving motive power is provided outside ring gear case 155, and rotates integrally with ring gear 152. Counter drive gear 170 is connected to a power transmission reduction gear RG. In this way, power split device PSD operates to output at least a part of the output from engine ENG to ring gear case 155 in accordance with the electric power and the motive power input into/output from motor generator MG1.

Furthermore, the motive power is transferred between counter drive gear 170 and power transmission reduction gear RG. Power transmission reduction gear RG drives a differential gear DEF coupled to front wheels 70L and 70R serving as driving wheels. Furthermore, on a downhill road and the like, rotation of the driving wheels is transmitted to differential gear DEF and power transmission reduction gear RG is driven by differential gear DEF.

Motor generator MG1 includes a stator 131 forming a rotating magnetic field, and a rotor 132 disposed within stator 131 and having a plurality of permanent magnets embedded therein. Stator 131 includes a stator core 133 and a three-phase coil 134 wound around stator core 133. Rotor 132 is coupled to the sun gear shaft that rotates integrally with sun gear 151 of power split device PSD. Stator core 133 is formed by stacking thin electromagnetic steel plates and fixed in a casing that is not shown.

The operation of motor generator MG1 as an electric motor described above is performed by drive-rotating rotor 132 through the interaction between a magnetic field formed by the permanent magnets embedded in rotor 132 and a magnetic field formed by three-phase coil 134. Furthermore, the operation of motor generator MG1 as a power generator described above is performed by generating electromotive force at opposite ends of three-phase coil 134 through the interaction between the magnetic field formed by the permanent magnets and the rotation of rotor 132.

Motor generator MG2 includes a stator 136 forming a rotating magnetic field, and a rotor 137 disposed within stator 136 and having a plurality of permanent magnets embedded therein. Stator 136 includes a stator core 138 and a three-phase coil 139 wound around stator core 138.

Rotor 137 is coupled via reduction gear RD to ring gear case 155 that rotates integrally with ring gear 152 of power split device PSD. Stator core 138 is, for example, formed by stacking thin electromagnetic steel plates and fixed in a casing that is not shown.

The operation of motor generator MG2 as a power generator described above is performed by generating electromotive force at the opposite ends of three-phase coil 139 through the interaction between the magnetic field formed by the permanent magnets and the rotation of rotor 137. Furthermore, the operation of motor generator MG2 as an electric motor described above is performed by drive-rotating rotor 137 through the interaction between the magnetic field formed by the permanent magnets and the magnetic field formed by three-phase coil 139.

Reduction gear RD provides deceleration by the structure in which a planetary carrier 166 as one of rotating elements of the planetary gear is fixed in the casing. In other words, reduction gear RD includes a sun gear 162 coupled to output shaft 160 of rotor 137, a ring gear 168 rotating integrally with ring gear 152, and a pinion gear 164 engaging with ring gear 168 and sun gear 162 for transmitting the rotation of sun gear 162 to ring gear 168. For example, the reduction ratio can be increased to twice or more by setting the number of teeth of ring gear 168 to twice or more the number of teeth of sun gear 162.

In this way, the rotating force of motor generator MG2 is transmitted through reduction gear RD to ring gear case 155 that rotates integrally with ring gears 152 and 168. In other words, motor generator MG2 is configured to apply motive power to a path from ring gear case 155 to the driving wheels. In addition, output shaft 160 of motor generator MG2 and ring gear case 155 may be coupled to each other in the state where reduction gear RD is not arranged, that is, without providing a reduction gear ratio.

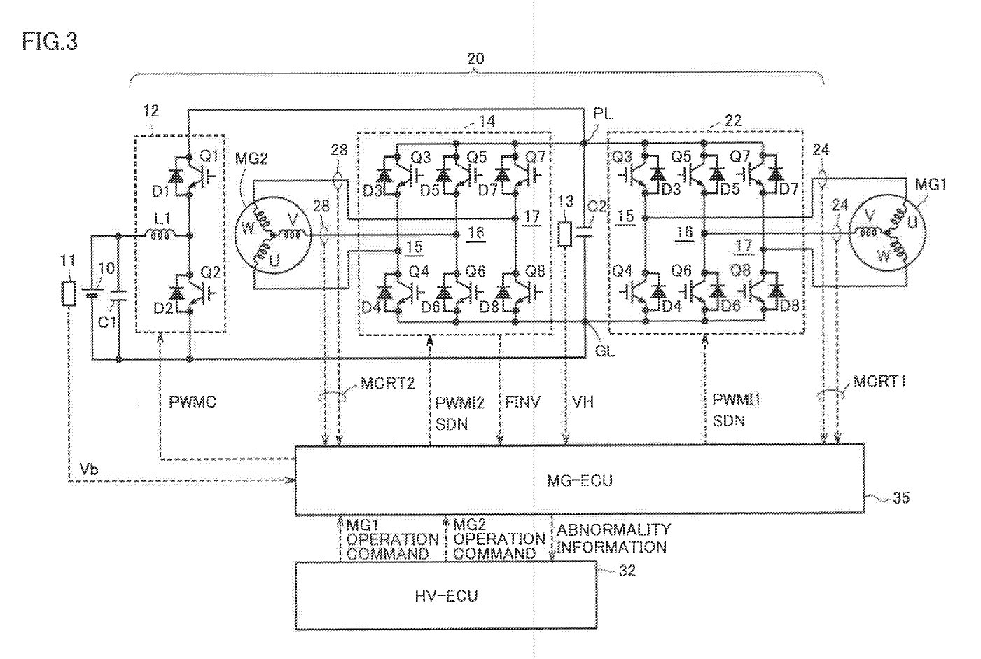

PCU 20 includes a converter 12, and inverters 14, 22. Converter 12 converts a DC voltage Vb from battery 10 and outputs a DC voltage VH between a positive electrode line PL and a negative electrode line GL. Furthermore, converter 12 is configured to be capable of bi-directionally converting a voltage, and serves to convert DC voltage VH between positive electrode line PL and negative electrode line GL into a charge voltage Vb for battery 10. Converter 12 will be described in detail with reference to FIG. 3.

Inverters 14 and 22 each are formed of a commonly-used three-phase inverter and convert DC voltage VH between positive electrode line PL and negative electrode line GL into an AC voltage. Then, inverters 14 and 22 output the converted AC voltages to motor generators MG2 and MG1, respectively. Furthermore, inverters 14 and 22 convert the AC voltages generated by motor generators MG2 and MG1 into DC voltages VH, and output the converted DC voltages VH between positive electrode line PL and negative electrode line GL. Inverters 14 and 22 will be described in detail with reference to FIG. 3.

FIG. 3 is a schematic block diagram showing the control configuration for motor generators MG1 and MG2. Referring to FIG. 3, in addition to converter 12 and inverters 14 and 22, PCU 20 includes capacitors C1, C2, voltage sensors 11, 13, and current sensors 24, 28.

ECU 30 shown in FIGS. 1 and 2 includes: an HV-ECU 32 generating a command for operating each of motor generators MG1 and MG2, and a voltage command value VHref (not shown) for converter 12; and an MG-ECU 35 for controlling converter 12, inverters 14 and 22 so as to cause an output voltage VH from converter 12 to follow voltage command value VHref and to cause motor generators MG1 and MG2 to operate according to each operation command.

Converter 12 includes: a reactor L1; switching elements Q1 and Q2, for example, formed of IGBT (Insulated Gate Bipolar Transistor) elements; and diodes D1 and D2. Reactor L1 has one end connected to positive electrode line PL of battery 10 and the other end connected between switching elements Q1 and Q2, that is, connected to the connection node between the emitter of switching element Q1 and the collector of switching element Q2. Switching elements Q1 and Q2 are connected in series between positive electrode line PL and negative electrode line GL. The collector of switching element Q1 is connected to positive electrode line PL while the emitter of switching element Q2 is connected to negative electrode line GL. Also, an antiparallel diode D1 is connected between the collector and the emitter of switching element Q1 while an antiparallel diode D2 is connected between the collector and the emitter of switching element Q2.

Inverter 14 includes a U-phase arm 15, a V-phase arm 16 and a W-phase arm 17. U-phase arm 15, V-phase arm 16 and W-phase arm 17 are provided in parallel between positive electrode line PL and negative electrode line GL. U-phase arm 15 includes switching elements Q3 and Q4 connected in series, V-phase arm 16 includes switching elements Q5 and Q6 connected in series, and W-phase arm 17 includes switching elements Q7 and Q8 connected in series. Also, antiparallel diodes D3 to D8 are connected to switching elements Q3 to Q8, respectively.

The connection node between the upper arm and the lower arm in each phase arm is connected to each phase end of each phase coil of motor generator MG2. Specifically, three coils having U-, V- and W-phases each have one end connected in common to a neutral point. The other end of the U-phase coil is connected to the connection node between switching elements Q3 and Q4; the other end of the V-phase coil is connected to the connection node between switching elements Q5 and Q6; and the other end of the W-phase coil is connected to the connection node between switching elements Q7 and Q8. Inverter 22 has the same configuration as that of inverter 14.

Voltage sensor 11 detects DC voltage Vb output from battery 10, and outputs the detected DC voltage Vb to MG-ECU 35. Capacitor C1 smoothes DC voltage Vb supplied from battery 10, and supplies the smoothed DC voltage Vb to converter 12.

Converter 12 boosts DC voltage Vb supplied from capacitor C1, and supplies the boosted DC voltage Vb to capacitor C2. Specifically, when converter 12 receives a signal PWMC from MG-ECU 35, it boosts DC voltage Vb in accordance with the time period during which switching element Q2 is turned on by signal PWMC, and supplies the boosted DC voltage to capacitor C2. During regeneration of motor generators MG 1 and 2, the DC voltage supplied from inverter 14 and/or inverter 22 through capacitor C2 is lowered for charging battery 10.

Capacitor C2 smoothes the DC voltage from converter 12, and supplies the smoothed DC voltage to inverters 14 and 22 through positive electrode line PL and negative electrode line GL. Voltage sensor 13 detects the voltage across capacitor C2, that is, an output voltage VH from converter 12 (corresponding to the input voltage of each of inverters 14 and 22; the same applies hereinafter), and outputs the detected output voltage VH to MG-ECU 35.

Based on a signal PWMI2 from MG-ECU 35, inverter 14 converts DC voltage VH from capacitor C2 into an AC voltage for driving motor generator MG2. Thereby, motor generator MG2 is driven so as to generate a torque designated by a torque command TR2.

Furthermore, during regenerative braking of hybrid vehicle 5, inverter 14 converts the AC voltage generated by motor generator MG2 into a DC voltage based on signal PWMI2 from MG-ECU 35, and supplies the converted DC voltage to converter 12 through capacitor C2. It is to be noted that the regenerative braking described herein includes a braking operation involving regenerative braking in the case of the foot brake operation by the driver operating hybrid vehicle 5 and an operation of decelerating the vehicle (or stopping acceleration) while performing regenerative power generation by releasing the accelerator pedal during vehicle running without a foot brake operation.

Based on signal PWMI1 from MG-ECU 35, inverter 22 converts the DC voltage from capacitor C2 into an AC voltage for driving motor generator MG1. Thereby, motor generator MG1 is driven so as to generate a torque designated by a torque command TR1.

In addition, the operation command issued from HV-ECU 32 includes an operation permission command/operation inhibition command (a gate shut-off command) for motor generators MG1 and MG2, torque commands TR1 and TR2, a rotation speed command, and the like. The operation command issued from HV-ECU 32 further includes an engine control instruction showing the output request to engine ENG (the engine power and the engine target rotation speed). According to this engine control instruction, the fuel injection, the ignition timing, the valve timing and the like for engine ENG are controlled.

Then, based on output voltage VH, a motor current MCRT2 and torque command TR2, MG-ECU 35 generates signal PWMI2 for performing switching control of switching elements Q3 to Q8 of inverter 14. Then, MG-ECU 35 outputs the generated signal PWMI2 to inverter 14. Furthermore, based on output voltage TH, motor current MCRT1 and torque command TR1, MG-ECU 35 generates signal PWMI1 for performing switching control of switching elements Q3 to Q8 of inverter 22. Then, MG-ECU 35 outputs the generated signal PWMI1 to inverter 22. In such cases, signals PWMI1 and PWMI2 are generated by feedback control using a sensor detected value, for example, according to the well-known PWM control scheme.

On the other hand, in the case where HV-ECU 32 issues a gate shut-off command for motor generator MG2, MG-ECU 35 generates a gate shut-off signal SDN such that each of switching elements Q3 to Q8 constituting inverter 14 stops the switching operation (all are turned off). Furthermore, in the case where HV-ECU 32 issues a gate shut-off command for motor generator MG1, MG-ECU 35 generates a gate shut-off signal SDN such that each of switching elements Q3 to Q8 constituting inverter 22 stops the switching operation (all are turned off).

Furthermore, based on voltage command value VHref, DC voltage Vb and output voltage VH, MG-ECU 35 generates a signal PWMC for performing switching control of switching elements Q1 and Q2 in converter 12, and outputs the generated signal PWMC to converter 12.

The information about abnormalities occurring in motor generators MG1 and MG2 that are detected by MG-ECU 35 is issued to HV-ECU 32, HV-ECU 32 is configured such that these pieces of abnormality information can be reflected in the operation commands for motor generators MG1 and MG2.

In the configuration shown in each of FIGS. 1 to 3, motor generator MG1 corresponds to the “first motor generator” in the present invention, and motor generator MG2 corresponds to the “second motor generator” in the present invention, HV-ECU 32 and MG-ECU 35 each form a “controller” in the present invention.

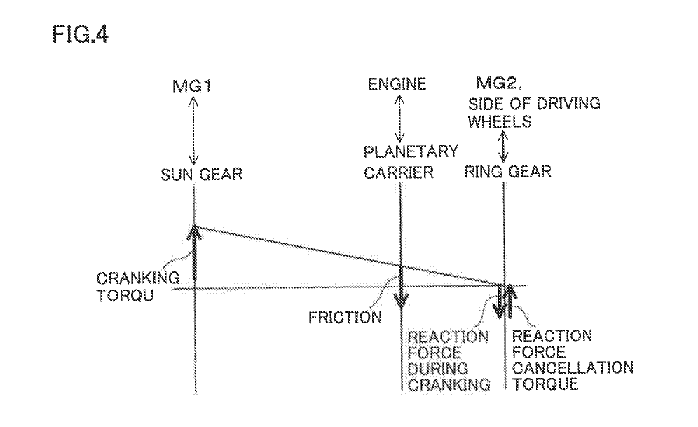

FIG. 4 is a collinear diagram illustrating the relation between the rotation speed and the torque of each component in power split device PSD at the start of the engine in the normal case. In this case, in hybrid vehicle 5 configured as described above, by the differential operation conducted by power split device PSD, the rotation speed of motor generator MG1, the rotation speed of engine ENG and the rotation speed of ring gear case 155 are changed such that the rotation speed difference between motor generator MG1 and engine ENG with respect to ring gear case 155 is maintained at a constant ratio, as shown in the collinear diagram in FIG. 4. In the following description, the torque and the rotation speed of motor generator MG2 are designated as Tm and Nm, respectively, while the torque and the rotation speed of motor generator MG1 are designated as Tg and Ng, respectively. Furthermore, the direction of torque Tm of motor generator MG2 that acts in the direction in which hybrid vehicle 5 is driven is defined as “positive”.

In the case where engine ENG is cranked when the vehicle is stopped, inverter 22 of motor generator MG1 is controlled by ECU 30 such that motor generator MG1 generates a cranking torque that allows torque exceeding the friction of engine ENG to be transmitted to engine ENG.

In this case, ring gear 152 of power split device PSD receives a torque caused by the reaction force produced during cranking. Accordingly, the driving force in the direction in which hybrid vehicle 5 is caused to run in the backward direction is exerted from ring gear 152 upon the side of front wheels 70L and 70R serving as driving wheels. If this driving force is not cancelled, hybrid vehicle 5 is caused to run in the backward direction. In order to prevent this backward movement, ECU 30 controls inverter 14 of motor generator MG2 so as to generate a reaction force cancellation torque for cancelling this reaction force from motor generator MG2.

However, in the case where abnormalities occur, for example, where motor generator MG2 turns into an uncontrollable state, the torque fluctuations caused by the cranking torque to driving wheels need to be prevented as described above. For this purpose, conventionally, cranking of engine ENG is inhibited when the shift position falls out of a P range, and when the vehicle speed is zero. Accordingly, the vehicle running mode cannot be shifted to a running mode using the driving force of engine ENG, so that the vehicle cannot run in a fail-safe mode.

The running mode using the driving force of engine ENG means a running mode in which the vehicle runs only with the torque transmitted directly to the driving wheels through power split device PSD from engine ENG while generating electric power with motor generator MG1 during a failure of motor generator MG2.

Accordingly, in the present embodiment, when engine ENG is started in the state where an abnormality occurs in motor generator MG2, ECU 30 executes three-phase ON control for inverter 14 so as to cause motor generator MG2 to generate a drag torque, thereby cancelling the torque transmitted from motor generator MG1 to the side of the driving wheels.

Three-phase ON control will be hereinafter described. Specifically, in a multi-phase and full-bridge type inverter 14 having each phase including an upper arm and a lower arm, all of the upper arms or all of the lower arms in the phases are controlled to be in an ON state.

When motor generator MG2 rotates as engine ENG rotates, the permanent magnet attached to rotor 137 rotates. Accordingly, an induction voltage is generated in a three-phase coil winding of motor generator MG2. In addition, the induction voltage generated in the coil winding is proportional to the rotation speed of motor generator MG2. Thus, when the rotation speed of motor generator MG2 rises, the induction voltage generated in motor generator MG2 also rises.

In the case where abnormalities occur in motor generators MG1 and MG2, generally, each of switching elements Q3 to Q8 constituting inverters 14 and 22 stops a switching operation (all are turned off) in response to a gate shut-off signal SDN, thereby stopping power supply to motor generators MG1 and MG2. When three-phase ON control is performed, inverter 14 for controlling power supply to motor generator MG2 is controlled such that the upper arms or the lower arms in U-phase arm 15, V-phase arm 16 and W-phase arm 17 are simultaneously turned into an ON state. For example, switching element Q3 in the U-phase upper arm, switching element Q5 in the V-phase upper arm and switching element Q7 in the W-phase upper arm are controlled to be simultaneously turned into an ON state. It is to be noted that control for simultaneously turning the upper arms or the lower arms of the multi-phase arms in the inverter into an ON state is referred to as “multi-phase ON control”.

By executing three-phase ON control for inverter 14, a current path is to be formed among switching element Q3, switching element Q5 and switching element Q7 when the magnet of motor generator MG2 rotates. Thereby, motor currents Iu, Iv and Iw showing alternating-current waveforms having approximately the same amplitude are induced in the U-phase coil winding, the V-phase coil winding and the W-phase coil winding, respectively, of motor generator MG2. Then, these induced motor currents cause formation of a rotating magnetic field, so that a drag torque (damping torque) is generated in motor generator MG2.

In other words, when an abnormality occurs in motor generator MG2, switching control based on the normal PWM control cannot be performed. However, if switching elements Q3 to Q8 of inverter 14 can be turned into an ON state or an OFF state, inverter 14 having a gate shut-off is switched into three-phase ON control, so that a drag torque can be generated in motor generator MG2.

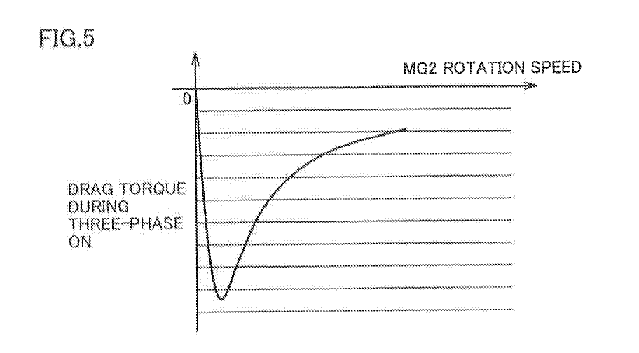

FIG. 5 is a diagram illustrating the relation between the torque and the rotation speed of motor generator MG2 during execution of three-phase ON control. As shown in FIG. 5, a drag torque (negative torque) is output from motor generator MG2 during three-phase ON control. This drag torque turns into a maximum torque at a prescribed rotation speed within a low rotation range of motor generator MG2.

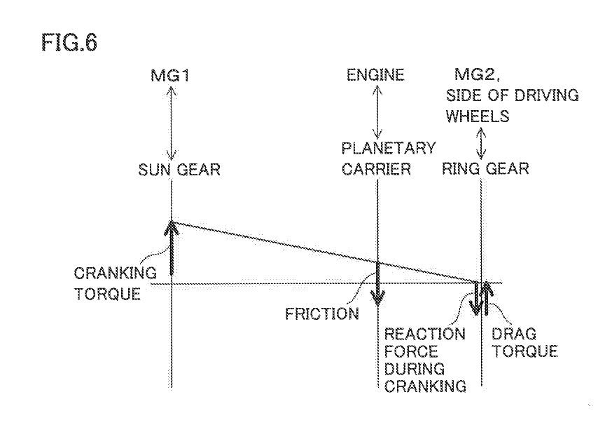

FIG. 6 is a collinear diagram illustrating the relation between the rotation speed and the torque of each component in power split device PSD at the start of engine ENG during execution of three-phase ON control for motor generator MG2. Referring to FIG. 6, the reaction force generated during cranking is cancelled by the drag torque generated from motor generator MG2, in place of the reaction force cancellation torque generated from motor generator MG2 shown in FIG. 4 in the normal case. Thereby, in the case where an abnormality occurs in motor generator MG2, even if the vehicle speed is zero and the shift range is not in a P range, hybrid vehicle 5 can be prevented from running in the backward direction during cranking.

Also in this case, the cranking torque generated from motor generator MG1 may be controlled such that the reaction force generated during cranking falls within a range of the drag torque. Furthermore, even in the case where a drag torque is generated only at a level at which the reaction force occurring during cranking cannot be completely cancelled, hybrid vehicle 5 can be prevented from running in the backward direction as long as the torque obtained by subtracting the drag torque from the torque generated by the reaction force during cranking falls within a range not exceeding the driving resistance for starting hybrid vehicle 5 from its stopped state.

In this way, even in the case where an abnormality occurs in motor generator MG2, the torque transmitted from motor generator MG1 to the side of the driving wheels is cancelled by the drag torque generated from motor generator MG2 when a start-up torque is transmitted from motor generator MG1 to engine ENG. Consequently, even in the case where an abnormality occurs in motor generator MG2, the torque transmitted to the side of the driving wheels can be cancelled at the start of engine ENG.

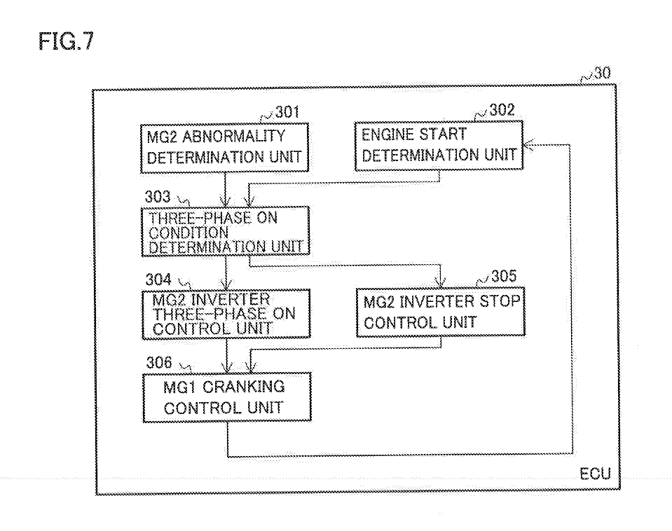

Specifically, the control for starting engine ENG can be executed as described below when an abnormality occurs in motor generator MG2. FIG. 7 is a functional block diagram schematically showing the configuration for executing control for starting engine ENG at the time when an abnormality occurs in motor generator MG2 according to the present embodiment. Referring to FIG. 7, the controller includes; a determination unit 301 configured to determine whether an abnormality occurs or not in motor generator MG2; a determination unit 302 configured to determine whether engine ENG has been started or not; a determination unit 303 configured to determine whether the three-phase ON conditions are satisfied or not; a control unit 304 configured to execute three-phase ON control for inverter 14 of motor generator MG2; a control unit 305 configured to execute control for stopping inverter 14 of motor generator MG2; and a control unit 306 configured to execute cranking control for motor generator MG1.

Determination unit 301 determines whether abnormalities occur or not in voltage sensor 13, current sensor 28, rotation angle sensor 52, and the like. Determination unit 302 determines whether engine ENG has been started or not.

In the case where determination unit 301 determines that an abnormality occurs in motor generator MG2 and determination unit 302 determines that engine ENG has not been started, determination unit 303 determines whether the conditions for executing three-phase ON control for motor generator MG2 have been satisfied or not, for example, whether the vehicle speed is zero or not, and whether the shift position is in a P range or not. If the vehicle speed is zero and the shift position is not in a P range; determination unit 303 determines that the conditions for executing three-phase ON control have been satisfied.

When determination unit 303 determines that the conditions for executing three-phase ON control have been satisfied, control unit 304 executes three-phase ON control for inverter 14 of motor generator MG2.

When determination unit 303 determines that the conditions for executing three-phase ON control have not been satisfied, control unit 305 executes control for stopping (shutting down) inverter 14 of motor generator MG2.

After execution of control by control unit 304 or control unit 305, or simultaneously with execution of this control, control unit 306 controls engine ENG to be cranked with motor generator MG1. Determination unit 302 determines whether engine ENG has been started or not as a result of control executed by control unit 306.

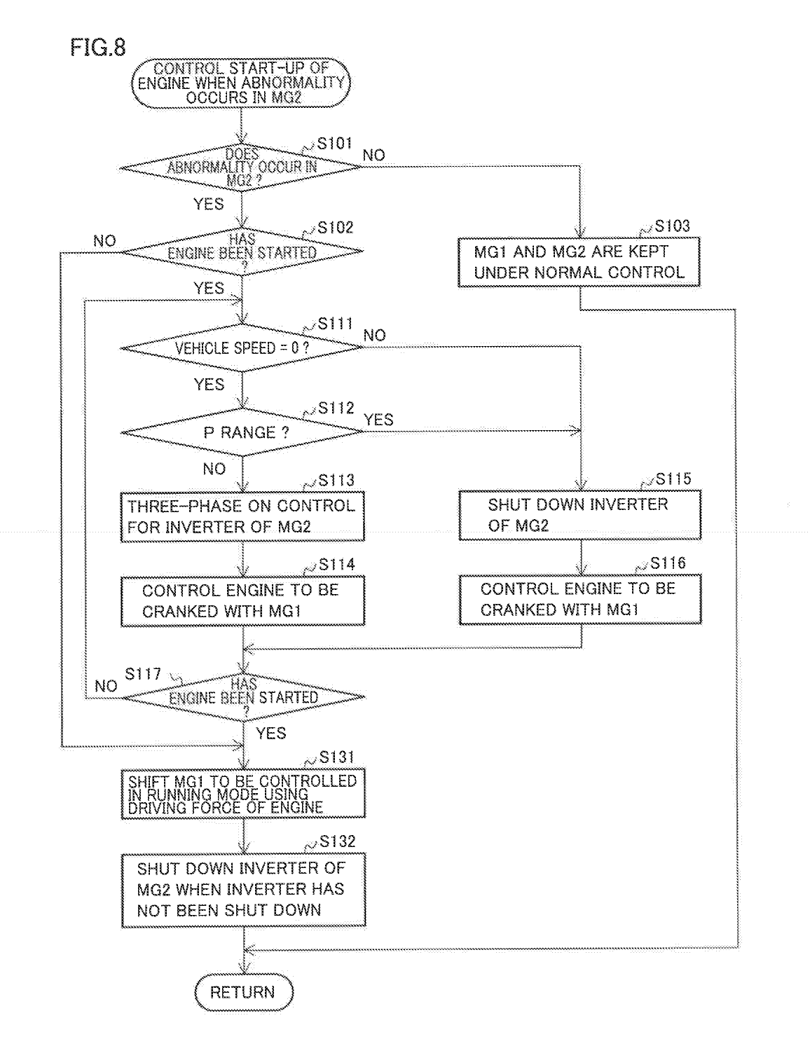

Such determination units 301 to 303 and control units 304 to 306 may be formed by a hardware circuit within ECU 30 serving as a controller, or may be implemented by a computer program (software) executed by ECU 30 as shown in FIG. 8 set forth below.

FIG. 8 is a flowchart illustrating the process flow of control for starting engine ENG at the time when an abnormality occurs in motor generator MG2. Referring to FIG. 8, this process is performed for every control period of ECU 30.

First, ECU 30 determines whether an abnormality occurs or not in motor generator MG2 (step (which will be hereinafter simply abbreviated as “S”) 101).

When ECU 30 determines that no abnormality occurs in motor generator MG2 (NO in S101) and motor generator MG2 normally operates, ECU 30 keeps motor generators MG1 and MG2 to be controlled in the same manner as that applied up to that point in time (S103). When ECU 30 determines that an abnormality occurs (YES in S101), it determines whether engine ENG has been started or not (S102).

When ECU 30 determines that engine ENG has not been started (YES in S102), it determines whether the vehicle speed is zero or not (S111). When ECU 30 determines that the vehicle speed is zero (YES in S111), it determines whether the shift position is in a parking range (P range) or not (S112).

When ECU 30 determines that the shift position is not in a P range (NO in S112), this ECU 30 executes three-phase ON control for inverter 14 of motor generator MG2 (S113). ECU 30 controls inverter 22 of motor generator MG1 to cause engine ENG to be cranked with motor generator MG1 (S114).

When ECU 30 determines that the vehicle speed is not zero NO in S111), or when ECU 30 determines that the shift position is in a P range (YES in S112), ECU 30 causes inverter 14 of motor generator MG2 to be shut down (stopped) (S115). Then, ECU 30 controls inverter 22 of motor generator MG1 to cause engine ENG to be cranked with motor generator MG1 (S116).

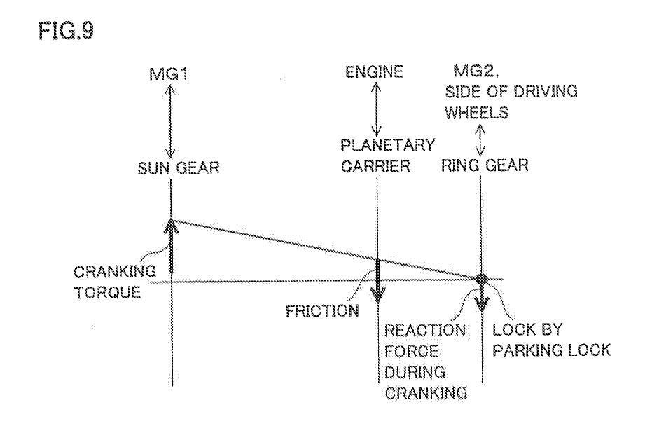

FIG. 9 is a collinear diagram illustrating the relation between the rotation speed and the torque of each component in power split device PSD at the start of engine ENG in the case of a parking range. Referring to FIG. 9, rotation of each of ring gear 168 and motor generator MG2 is mechanically locked by a parking lock implemented by changing the shift position into a parking range, in place of the reaction force cancellation torque generated from motor generator MG2 shown in FIG. 4 in the normal case. Accordingly, the reaction force generated during cranking is cancelled. Thereby, when the shift position is in a P range in the state where an abnormality occurs in motor generator MG2, hybrid vehicle 5 can be prevented from running in the backward direction during cranking.

Furthermore, when the vehicle speed is not zero, that is, during running of the vehicle, the inertial force of hybrid vehicle 5 is applied to ring gear 168, so that the reaction force occurring during cranking is cancelled by this inertial force. Thereby, when the vehicle speed is not zero in the state where an abnormality occurs in motor generator MG2, the vehicle speed of hybrid vehicle 5 can be prevented from greatly changing during cranking.

After S114 and S116, ECU 30 determines whether engine ENG has been started or not (S117). When ECU 30 determines that engine ENG has not been started (NO in S117), it returns the process to S111.

When ECU 30 determines that engine ENG has not been started (NO in S102), that is, the engine is being operated, and determines that start-up of engine ENG has been completed (YES in S117), ECU 30 shifts motor generator MG1 to be controlled in a running mode using the driving force of engine ENG (S131). Then, if inverter 14 of motor generator MG2 is not shut down, ECU 30 shuts down this inverter 14 (S132).

Determination made by determination unit 301 in FIG. 7 corresponds to determination made by ECU 30 in the process in S101 in FIG. 8. Determination made by determination unit 302 in FIG. 7 corresponds to determination made by ECU 30 in the processes in S102 and 8117 in FIG. 8. Determination made by determination unit 303 in FIG. 7 corresponds to determination made by ECU 30 in the processes in S111 and S112 in FIG. 8.

Control executed by control unit 304 in FIG. 7 corresponds to control executed by ECU 30 in the process in S113 in FIG. 8. Control executed by control unit 305 in FIG. 7 corresponds to control executed by ECU 30 in the process in S115 in FIG. 8. Control executed by control unit 306 in FIG. 7 corresponds to control executed by ECU 30 in the processes in S144 and S116 in FIG. 8.

The embodiments as described above will be hereinafter summarized.

(1) Hybrid vehicle 5 in the above-described embodiment includes engine ENG, motor generator MG1, three-phase motor generator MG2, power split device PSD, inverters 14 and 22, and ECU 30.

Power split device PSD includes: sun gear 151 coupled to the output shaft of motor generator MG1; ring gear 152 coupled to the output shaft of motor generator MG2: and planetary carrier 154 coupled to the output shaft of engine ENG and extracting the orbital motion of each of a plurality of pinion gears 153 through connection to the rotation axis of the plurality of pinion gears 153 engaged with both of sun gear 151 and ring gear 152. In accordance with the motive power input/output through two of sun gear 151, ring gear 152 and planetary carrier 154, power split device PSD thus receives/outputs motive power through remaining one of sun gear 151, ring gear 152 and planetary carrier 154.

Inverter 22 serves to control power supply to motor generator MG1. Inverter 14 is a multi-phase and full-bridge type inverter having each phase including an upper arm and a lower arm, and serves to control power supply to motor generator MG2. ECU 30 serves to control the outputs of motor generators MG1, MG2 and engine ENG.

When an abnormality occurs in motor generator MG2, ECU 30 executes control A to start engine ENG. Control A includes: control a1 for causing engine ENG to be cranked with motor generator MG1; and control a2 for controlling the upper arm or the lower arm in each phase of inverter 14 to be turned into an ON state.

In this way, even if an abnormality occurs in motor generator MG2, when control a1 is executed to transmit the start-up torque from motor generator MG1 to engine ENG, the torque transmitted from motor generator MG1 to the side of the driving wheels is cancelled by the drag torque generated from motor generator MG2 by executing control a2. Consequently, even if an abnormality occurs in motor generator MG2, the torque transmitted to the side of the driving wheels can be cancelled at the start of engine ENG.

(2) When an abnormality occurs in motor generator MG2, and the shift range is not in a parking range, ECU 30 executes control A to start engine ENG. On the other hand, when an abnormality occurs in motor generator MG2, and the shift range is in a parking range, ECU 30 executes control a1 to stop inverter 14 and start engine ENG.

In this way, when the shift range is not in a parking range, the above-mentioned control A is executed to start engine ENG. On the other hand, when the shift range is in a parking range, rotation of motor generator MG2 is mechanically locked. Accordingly, it is not necessary to cause motor generator MG2 to generate the torque for cancelling the torque transmitted to the side of the driving wheels. Consequently, engine ENG can be started in the state where wasteful power consumption in inverter 14 is eliminated.

[Modifications]

Modifications of the above-described embodiments will be hereinafter described.

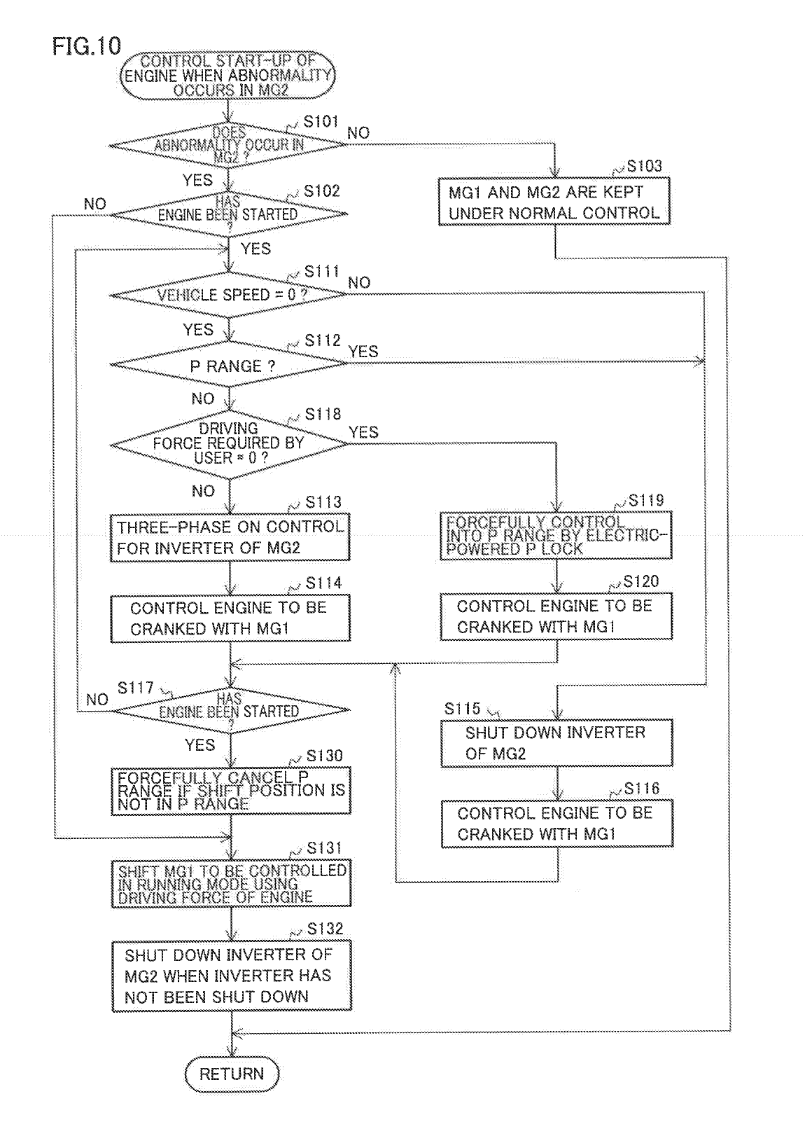

(1) In the control flow in FIG. 8 as described above, in the case where the vehicle speed is zero, the shift range is in a P range and there is no driving force required by the user, ECU 30 may execute control for forcefully bringing the shift range into a P range. FIG. 10 is a flowchart illustrating the process flow of a modification of control for starting engine ENG when an abnormality occurs in motor generator MG2. Referring to FIG. 10, the control flow in FIG. 10 is the same as that in FIG. 8 except for S118 to S120 and S130.

When ECU 30 determines that the vehicle speed is zero (YES in S111) and the shift range is not in a P range NO in S112), this ECU 30 determines based on an accelerator pedal position AP detected by an accelerator position sensor 44 whether an accelerator pedal is operated or not, thereby determining whether the driving force required by the user is approximately zero or not (S118). When ECU 30 determines that the driving force is not approximately zero (NO in S118), that is, the accelerator pedal is depressed, this ECU 30 executes three-phase ON control for inverter 14 of motor generator MG2 to cause the engine to be cranked with motor generator MG1, as described in the above S113 and S114 with reference to FIG. 8.

When ECU 30 determines that the driving force required by the user is approximately zero (YES in S118), that is, determines that the accelerator pedal is not depressed, this ECU 30 causes an electric-powered parking lock mechanism to lock ring gear 152, thereby controlling the shift range to be forcefully in a P range. Then, ECU 30 controls inverter 22 of motor generator MG1 such that engine ENG is cranked with motor generator MG1 (S120). After S120, ECU 30 advances the process to S117 described above.

When ECU 30 determines that the engine has been started (YES in S117) and the shift position is not in a P range, ECU 30 cancels the state where the shift range is forcefully brought into a P range in S119. After S130, ECU 30 advances the process to S131 described above.

Thereby, even if an abnormality occurs in motor generator MG2, the vehicle speed is zero, and the shift position is not in a P range, but if the driving force required by the user is approximately zero, the shift range is forcefully controlled to be in a P range when the start-up torque is transmitted from motor generator MG1 to engine ENG, thereby locking rotation of motor generator MG2, with the result that the torque transmitted to the side of the driving wheels can be more reliably cancelled.

In the state where an abnormality occurs in motor generator MG2, and when prescribed conditions are satisfied, for example, when the shift range is not in a parking range, the vehicle speed is zero and the driving force required by the user is zero, ECU 30 causes ring gear 152 to be mechanically locked and controls engine ENG to be cranked with motor generator MG1, thereby starting engine ENG. On the other hand, in the state where an abnormality occurs in motor generator MG2, and when the prescribed conditions mentioned above are not satisfied, ECU 30 controls engine ENG to be cranked with motor generator MG1, and controls the upper arm or the lower arm of each phase in inverter 14 to be in an ON state, thereby starting engine ENG.

In this way, when the prescribed conditions are not satisfied, the above-mentioned control A is executed to start engine ENG. On the other hand, when the prescribed conditions are satisfied, ring gear 152 is locked and rotation of motor generator MG2 is mechanically locked. Accordingly, it is not necessary to cause motor generator MG2 to generate the torque for cancelling the torque transmitted to the side of the driving wheels. Consequently, engine ENG can be started in the state where wasteful power consumption in inverter 14 is eliminated.

Although the embodiments of the present invention have been described as above, it should be understood that the embodiments disclosed herein are illustrative and non-restrictive in every respect. The scope of the present invention is defined by the terms of the claims, and is intended to include any modifications within the meaning and scope equivalent to the terms of the claims.

What is claimed is:

1. A hybrid vehicle comprising:
an engine;
a first motor generator;
a drive shaft connected to driving wheels;
a planetary gear mechanism mechanically coupling the engine, the first motor generator and the drive shaft;
a second motor generator coupled to the drive shaft;
a first inverter configured to control power supply to the first motor generator;
a second inverter configured to control power supply to the second motor generator, the second inverter being a multi-phase and full-bridge type inverter having an upper arm and a lower arm in each phase; and
a controller configured to control outputs of the first motor generator, the second motor generator and the engine,
the controller being configured to execute specific control for stalling the engine when the hybrid vehicle is in a stopped state and an abnormality occurs in the second motor generator, the specific control including
(i) first control for controlling the engine to be cranked with the first motor generator, and
(ii) second control for controlling the upper arm of each phase or the lower arm of each phase of the second inverter to be turned into an ON state.

2. The hybrid vehicle according to claim 1, wherein
in a case where the engine is started when an abnormality occurs in the second motor generator and when a shift range is in a parking range, the controller is configured to stop the second inverter and start the engine using the first motor generator.

3. The hybrid vehicle according to claim 1, wherein
the planetary gear mechanism includes a sun gear coupled to an output shaft of the first motor generator, a ring gear coupled to an output shaft of the second motor generator, and a planetary carrier coupled to an output shaft of the engine, and
in a case where the engine is started when an abnormality occurs in the second motor generator, when a shift range is not in a parking range, when the vehicle speed is zero, and when driving force required by a user is zero, the controller is configured to mechanically lock the ring gear, and start the engine using the first motor generator.
